(19) United States
(12) Patent Application Publication
(10) Pub. No.: US 2008/0266474 A1
(43) Pub. Date: Oct. 30, 2008

(54) LIQUID CRYSTAL PANEL AND LIQUID CRYSTAL DISPLAY USING THE SAME

(75) Inventor: Ichiro Hazeyama, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD., Kawasaki (JP)

(21) Appl. No.: 12/109,700

(22) Filed: Apr. 25, 2008

(30) Foreign Application Priority Data
Apr. 27, 2007 (JP) 2007-119687

(51) Int. Cl. G02F 1/133

(52) U.S. Cl. 349/39

(57) ABSTRACT

In a liquid crystal panel of the present invention, a common storage line is connected to a counter electrode by means of a conductive convex structure in a display area, and wiring resistance of the common storage line is made smaller than wiring resistance of a gate line. By making the wiring resistance of the common storage line smaller, a flicker and crosstalk can be reduced. Even in a large-sized liquid crystal panel, a liquid crystal panel having a good picture quality and a liquid crystal display using the same can be obtained.

This application is based upon and claims the benefit of priority from Japanese patent application No. 2007-119687, filed Apr. 27, 2007, the disclosure of which is incorporated herein in its entirety by reference.

### BACKGROUND OF THE INVENTION

This invention relates to a liquid crystal panel and a liquid crystal display using the same and, in particular, to a liquid crystal panel capable of reducing a flicker and crosstalk and a liquid crystal display using the same.

In place of a Cathode Ray Tube (CRT) that is a conventional display apparatus, a liquid crystal display having a thin thickness and space-saving becomes widely used in recent years. In a personal computer or a television set, a liquid crystal display has already become the mainstream in place of a CRT. A liquid crystal display becomes common for an industrial monitor or a medical monitor for which high picture quality is further required. For that reason, display quality and a large screen comparable to a CRT are required for these liquid crystal displays. However, in the case where a liquid crystal display is caused to be large, a wiring length is increased in a conventional structure, and with this resistance of a common storage line is increased and signal propagation delay time is increased. A problem occurs that the resistance of the common storage line is further increased and the signal propagation delay time is further increased due to reduction of a wiring width with high resolution of pixels.

A conventional liquid crystal panel and a liquid crystal display will be described with reference to FIGS. 1, 2. FIG. 1 shows a configuration diagram of a conventional liquid crystal display, and FIG. 2 shows a sectional view of a liquid crystal panel. The liquid crystal display is constructed from a display area 28 in which pixels are arranged in a matrix manner, a scanning circuit 4 for causing each pixel in the display area 28 to be displayed, a common potential supply circuit 5, and a data circuit 6. Each pixel of the liquid crystal panel is constructed from a TFT (Thin Film Transistor) 10, a pixel electrode 11 and a storage capacitor 27, and the pixels are arranged in a matrix manner.

A gate line 7 from the scanning circuit 4 is connected to a gate of the TFT 10 by means of a signal for activating each pixel. A data line 9 from the data circuit 6 is connected to a drain of the TFT 10 by means of a data signal for each pixel. A source of the TFT 10 of a switching element is connected to the pixel electrode 11, and the storage capacitor 27 is formed between the pixel electrode 11 and the common storage line 8. Reference potential from the common potential supply circuit 5 is connected to the common storage line 8 to keep potential of the common storage line 8 at the reference potential. The gate lines 7, the common storage lines 8 and the data lines 9 are arranged so as to intersect as a row (Xm−1, Xm) and a column (Yn, Yn+1) of a pixel matrix. The TFT 10 of the switching element disposed at an intersection (Xm, Yn) is selected by the gate line 7, voltage is applied to the pixel electrode 11 by means of the data signal from the data line 9, and the TFT 10 is chromatically displayed in accordance with the data signal.

In a liquid crystal panel 1, a TFT substrate 2 and a counter substrate 3 are sealed with a seal material 13, and the inside is filled with a liquid crystal material 14. The inside of the display area 28 is a region in which pixels are arranged in a matrix manner, that is, a region in which a screen is displayed. For ease of explanation, FIG. 2 shows the gate line 7 and the common storage line 8 in the display area 28. A counter electrode 12 of the counter substrate 3 and the common storage line 8 of the TFT substrate 2 are connected via a conductive convex structure 15 outside the edge of the display area 28. Thus, the common storage line 8 of the TFT substrate 2 is electrically connected to the counter electrode 12 of the counter substrate 3 outside the display area 28.

Potential of the common storage line 8 is varied under the influence of potential variation of the data line 9 in the case of a polarity inversion drive. However, the potential is restored to original reference potential by means of the reference potential applied from the common potential supply circuit 5 after a given period of time. In the case where a screen size or resolution is small, there is no influence on picture quality because potential variation time of the common storage line 8 is sufficient short and the potential is restored to the reference potential for a short time. However, with a large screen, a wiring length becomes long, and a region where the potential is restored to the reference potential in data writing time occurs in the display area. A problem that in this region the common storage line 8 cannot be restored to the reference potential in data writing time and a harmful influence is exerted on the picture quality, whereby display picture quality is deteriorated is found by knowledge of an inventor of the present application.

In the conventional structure, as means for preventing increase in resistance of the common storage line due to increase in the wiring length with a large screen and increase in the signal propagation delay time with the increase in the resistance, increase in a wiring width, increase of a wiring thickness, or a low-resistance conductor have been adopted. However, the increase of the wiring width leads to decrease in an opening ratio, and this causes brightness to be deteriorated or hinders high resolution. Further, the increase of the wiring thickness causes increase in a process load, and therefore, it is undesirable because this leads to increase in costs and a decline in productivity. Moreover, there is restriction on a material that can be selected for a wiring material, and it is not easy to realize the material. Thus, resistance of the common storage line is increased with the screen of the liquid crystal panel being large-sized, and signal propagation delay time is increased. Therefore, a problem remains that picture quality of a liquid crystal panel having a large screen is deteriorated.

As a measure for deterioration of display picture quality of such a liquid crystal panel, there are the following documents as prior art to reduce resistance of a common storage line by connecting a counter electrode to a common storage line. Patent Document 1 (Japanese Patent No. 3014291) discloses that a conductive film is formed on a columnar spacer that is to be formed at a counter substrate side, and a counter electrode of the counter substrate is connected to a common storage line of a TFT substrate. This prior art merely provides a method of improving in-plane potential variation of the counter electrode in inversion drive of common voltage VCOM. In an active matrix type liquid crystal panel that drives common voltage VCOM as constant potential, this prior art provides no explanation about a connecting portion for connecting a counter electrode to a common storage line, which is to be required to achieve a uniform operation for each pixel.

Patent Document 2 (Japanese Patent Application Publication No. 2000-275607) discloses a technique that common potential of a TFT substrate and a counter substrate is connected at a proximal end or a distal end of each of the substrates so that the common potential becomes optimal common potential. However, in an existing large-sized liquid crystal panel, it is not enough to connect common potential of the TFT substrate and the counter substrate at a proximal end or a distal end of each of the substrates.

As described above, with a screen of a liquid crystal panel being large-sized, the signal propagation delay time is increased due to increase in resistance of the common storage line, whereby the common storage line cannot be restored to the reference potential within data writing time. For that reason, there is a problem that a flicker or crosstalk occurs and display picture quality is thus deteriorated. As a solution to this problem, there is a technique that the counter electrode is connected to the common storage line. However, in an existing large-sized liquid crystal panel, it is not enough to connect the counter electrode to the common storage line at a proximal end or a distal end of a display portion as disclosed in Patent Document 2. Further, there is a problem that no explanation about a connecting portion for connecting the counter electrode to the common storage line, which is to be required to achieve a uniform operation for each pixel, is provided in Patent Document 1.

### SUMMARY OF THE INVENTION

In view of these problems, it is an object of the present invention to provide techniques to electrically connect a counter electrode of a counter substrate to a common storage line of a TFT substrate in a display area by means of a conductive convex structure. According to a configuration of the present invention, resistance of the common storage line can be reduced, signal propagation delay time can be shortened, and a flicker and crosstalk can be reduced. It is another object of the present invention to provide a liquid crystal panel capable of reducing such a flicker and crosstalk and a liquid crystal display using the same.

In order to solve the above problems, the present application basically adopts the following techniques. It will readily be understood that the present application also encompasses applied techniques as various modifications without departing from the technical scope of the present invention.

A liquid crystal panel of the present invention is a liquid crystal panel including a structure in which a counter substrate and a TFT substrate are bonded with a seal material and a liquid crystal material is filled between the counter substrate and the TFT substrate, wherein a plurality of pixels in each of which a gate line, a common storage line and a data line are arranged so that the data line intersects with the gate line and the common storage line are arranged in a display area in a matrix manner, the common storage line formed on the TFT substrate is connected to wiring from the common potential supply circuit outside the display area and further connected to the counter electrode formed on the counter substrate, and wherein in each pixel of the display area, the common storage line and the counter electrode in the display area are connected to each other so that a potential restoration period (tc) of the common storage line in each pixel becomes a length of a period of time equal to or less than a data entry period (tg).

Further, a liquid crystal panel of the present invention is a liquid crystal panel including a structure in which a counter substrate and a TFT substrate are bonded with a seal material and a liquid crystal material is filled between the counter substrate and the TFT substrate, wherein a plurality of pixels in each of which a gate line, a common storage line and a data line are arranged so that the data line intersects with the gate line and the common storage line are arranged in a display area in a matrix manner, the common storage line formed on the TFT substrate is connected to wiring from the common potential supply circuit outside the display area and further connected to the counter electrode formed on the counter substrate, and the gate line formed on the TFT substrate is connected to wiring from the scanning circuit outside the display area, and wherein in each pixel of the display area, the common storage line and the counter electrode in the display area are connected to each other so that common wiring resistance (Rc) from a point at which a common storage line and a storage capacitor are connected to each other to a point at which the common storage line is connected to wiring from the common potential supply circuit becomes a resistance value equal to or less than gate wiring resistance (Rg) from a gate electrode to a point at which the gate line is connected to wiring from the scanning circuit.

Further, a liquid crystal display of the present invention is the liquid crystal display comprising the liquid crystal panel as described above, wherein the liquid crystal display is provided with at least a drive circuit and a light source for backlighting.

In the liquid crystal panel of the present invention, the counter electrode of the counter substrate is connected to the common storage line of the TFT substrate in the display area by means of the conductive convex structure. For that reason, it is possible to achieve effects that resistance of the common storage line can be reduced, and signal propagation delay time can be shortened. According to the configuration of the present invention, it is possible to provide a liquid crystal panel capable of reducing a flicker and crosstalk and a liquid crystal display using the same.

### BRIEF DESCRIPTION OF THE DRAWINGS

FIG. 1 is a configuration diagram of a conventional liquid crystal display;

FIG. 2 is a sectional view of the conventional liquid crystal panel;

FIG. 3 is a sectional view of a liquid crystal panel according to the present invention;

FIG. 4 is a configuration diagram of the liquid crystal display according to the present invention;

FIG. 5 is a schematic view in which a subpixel checkered pattern is displayed on the liquid crystal panel;

FIG. 6 is an explanatory drawing showing a method of dividing a display area of the liquid crystal panel;

FIG. 7 is a potential waveform diagram of a pixel of the liquid crystal panel in which a flicker does not occur;

FIG. 8 is a potential waveform diagram of a pixel of the liquid crystal panel in which a flicker occurs;

FIG. 9 is a display screen on which a whole white window screen is displayed in the vicinity of the center of the screen;

FIG. 10 is a display screen for explaining display abnormality in FIG. 8;

FIG. 11 is a sectional view for explaining a first form of a conductive convex structure in the liquid crystal panel;

FIG. 12 is a sectional view for explaining a second form of the conductive convex structure in the liquid crystal panel;

FIG. 13 is a sectional view for explaining a third form of the conductive convex structure in the liquid crystal panel;

FIG. 14 is a sectional view for explaining a first structure of the conductive convex structure in the liquid crystal panel;

FIG. 15 is a sectional view for explaining a second structure of the conductive convex structure in the liquid crystal panel;

FIG. 16 is a sectional view for explaining a third structure of the conductive convex structure in the liquid crystal panel;

FIG. 17 is a sectional view for explaining a size of the conductive convex structure in the liquid crystal panel; and

FIG. 18 is a configuration diagram of a liquid crystal display using the liquid crystal panel of the present invention.

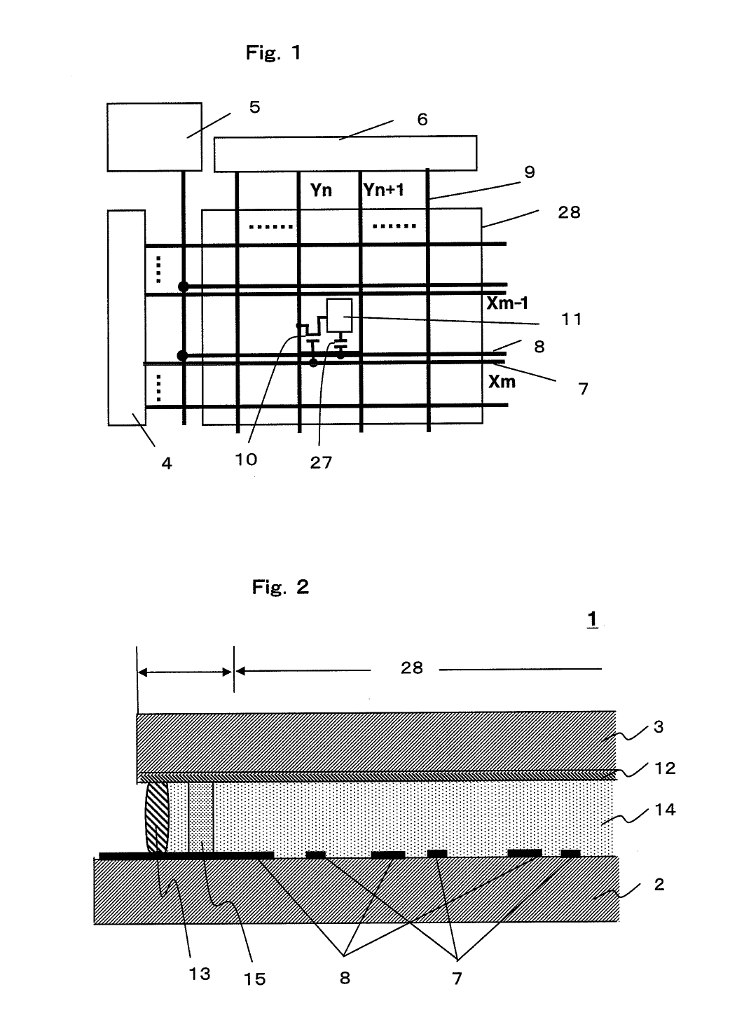

### DESCRIPTION OF THE EXEMPLARY EMBODIMENTS

Preferred exemplary embodiments of a liquid crystal panel and a liquid crystal display using the same according to the present invention will now be described with reference to the appending drawings. However, the present invention is not limited to the following embodiments. It will readily be understood that various modifications can be made without departing from the scope of the present invention and the present application also encompasses these modifications. Further, although a Twisted Nematic (TN) type liquid crystal panel will be described in embodiments, the present invention can be applied to other type liquid crystal panels that have a counter electrode in a counter substrate, such as a Vertical Aligned (VA) type liquid crystal panel, without departing from the spirit and scope of the present invention.

### Exemplary Embodiment 1

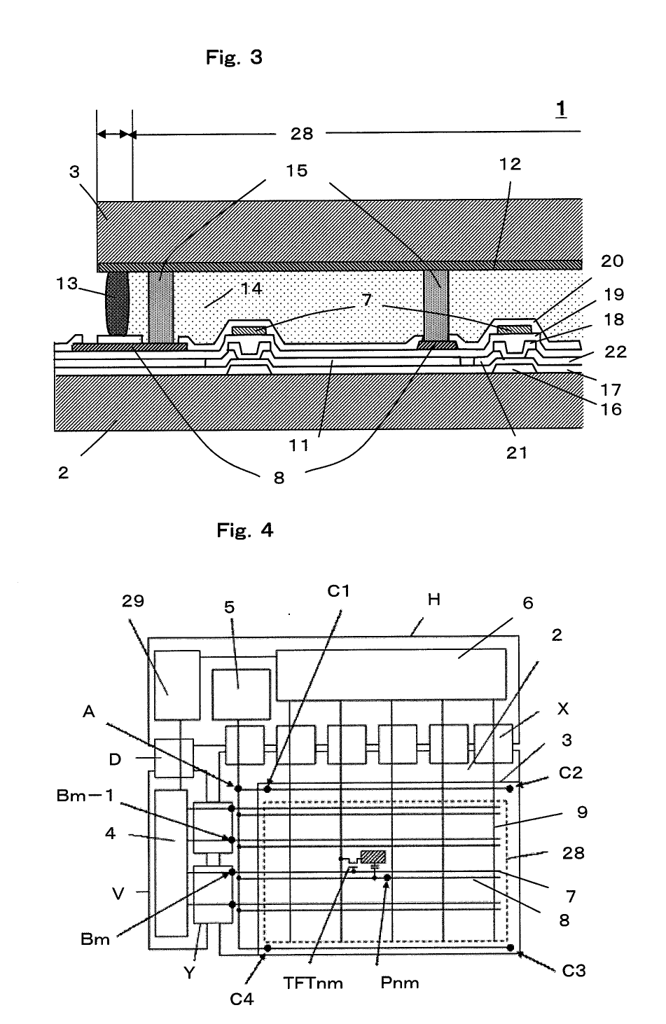

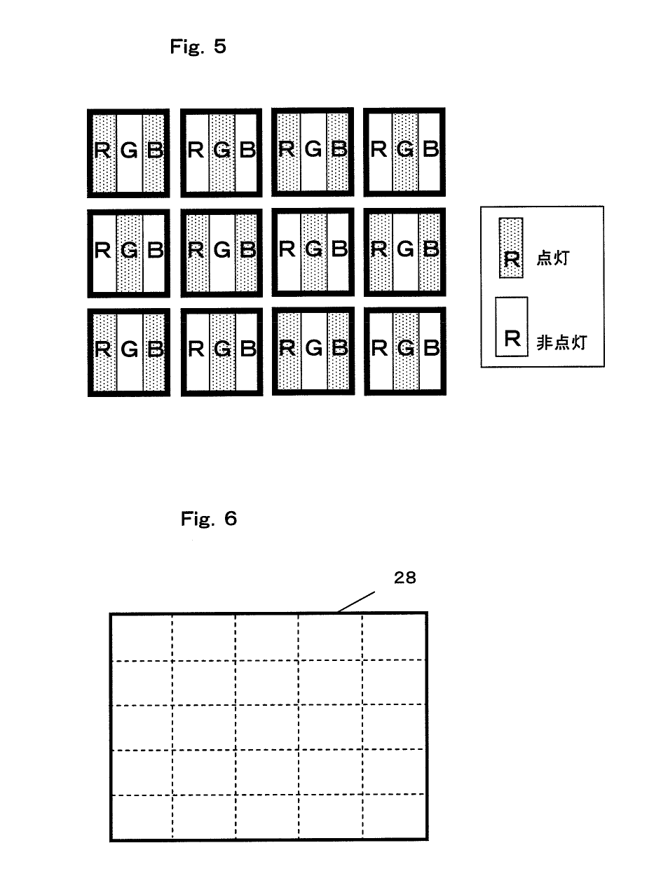

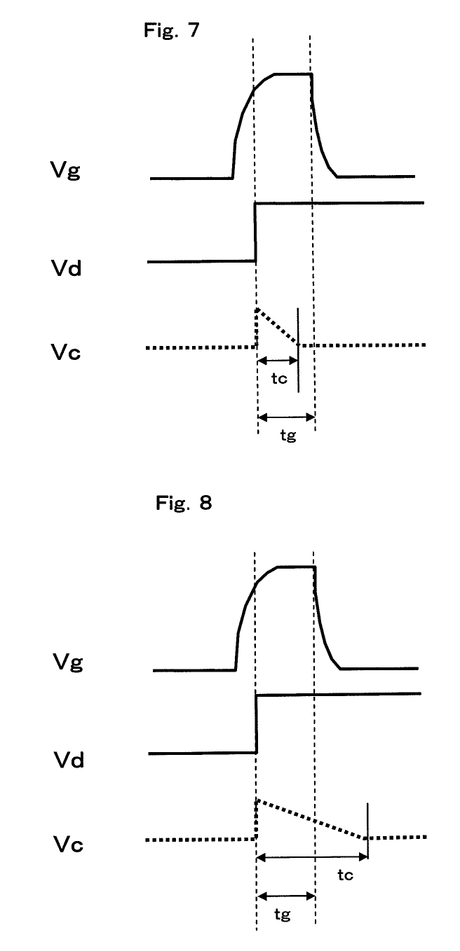

A first exemplary embodiment of a liquid crystal panel according to the present invention will now be described with reference to FIGS. 3 to 8. FIG. 3 shows a sectional view of a liquid crystal panel, and FIG. 4 shows a configuration diagram of the liquid crystal display. FIG. 5 shows a schematic view in which a subpixel checkered pattern is displayed, and FIG. 6 shows an explanatory drawing of a method of dividing a display area. FIGS. 7 and 8 show potential waveform diagrams.

As shown in FIG. 3, a liquid crystal panel 1 of the present invention includes a structure in which a counter substrate 3 and a TFT substrate 2 are bonded with a seal material 13, and a liquid crystal material 14 is filled between the counter substrate 3 and the TFT substrate 2. In this regard, the counter substrate can become a color filter substrate by disposing a color layer such as red, blue and green as needed. Moreover, in the inside of a display area 28, a common storage line 8 is connected to a counter electrode 12 through conductive convex structures 15. FIG. 3 shows an example in which two conductive convex structures 15 are provided in the display area.

A TFT is constructed from, for example, a light shielding film 16 made of Cr, an insulation film 17 made of SiOx or the like, an amorphous-Silicon 18, a silicon nitride 19, a gate line 7, and a protective film 20 on the TFT substrate 2. The TFT is configured from the gate line 7 as a gate electrode, a drain 21 and a source 22. A pixel electrode 11 is connected to the TFT. Here, since other configuration of a pixel including the TFT is a general configuration, explanation thereof is omitted. Connection between the common storage line 8 and the counter electrode 12, which is related to the present invention, will be described mainly.

Connection of the whole liquid crystal display will be described with reference to FIG. 4. A liquid crystal display is constructed from a liquid crystal display panel, a circuit board V and a circuit board H. The liquid crystal display panel includes a TFT substrate 2 and a counter substrate 3. The circuit board V includes a scanning circuit 4. The circuit board H includes a data circuit 6, a common potential supply circuit 5 and a control circuit 29. Moreover, the circuit board V is connected to the circuit board H through a connection board D. The circuit board H is connected to the liquid crystal panel through connection boards X. The circuit board V is connected to the liquid crystal panel through connection boards Y. In FIG. 4, with respect to pixels arranged in the inside of the display area 28 in a matrix manner, the gate lines 7 and the common storage lines 8 are wired in a cross direction, and the data lines 9 are wired in a longitudinal direction. The data lines 9 supply data signals to the respective pixels from the data circuit 6, The gate lines 7 are electrically connected to the scanning circuit 4 at connecting points (Bm, Bm−1) outside the display area 28 of the TFT substrate 2 to supply gate potential to the respective pixels.

The common storage lines 8 are connected to wiring from the common potential supply circuit 5 outside the display area 28 of the TFT substrate 2 to supply reference potential to the respective pixels. Common storage lines for connecting the counter electrodes to upper and lower sides outside the display area are further provided as common storage lines. The common storage line for connection shown in the upper side of FIG. 4 is electrically connected to the common potential supply circuit 5 at a connecting point A, and is further connected to the counter electrode 12 formed on the counter substrate 3 at connecting points C1, C2. Moreover, the common storage line for connection shown in the lower side of FIG. 4 is electrically connected to the wiring from the common potential supply circuit 5, and is further connected to the counter electrode 12 formed on the counter substrate 3 at connecting points C4, C3. However, these connecting points are not particularly limited, and can be provided outside the display area appropriately. In a conventional liquid crystal display, all connecting points between these common storage lines and counter electrodes are provided outside a display area in this manner.

In the present invention, the common storage lines 8 is further electrically connected to the counter electrode 12 at a connecting point Pnm (plural points or single point) in the inside of the display area 28 by means of the conductive convex structure 15. Although the connecting point Pnm is shown as a single point at the central part in the display area 28 in FIG. 4, plural connecting points can be provided by dividing the display area 28 as shown in FIG. 6. Here, “n” and “m” indicate a pixel connected to an n^{th} data line and an m^{th} gate line of pixels arranged in a matrix manner (hereinafter, referred to as the “pixel TFTnm”). The common storage line 8 is connected to the counter electrode 12 by means of the conductive convex structure 15 at the connecting point Pnm. Description of a connecting point Pnm indicates the case where a common storage line 8 is connected to a counter electrode 12 by means of a conductive convex structure 15 at a point Pnm. Simple description of a point Pnm indicates a point Pnm of a pixel TFTnm.

Hereinafter, a 19-inch liquid crystal panel in which a display area of a liquid crystal panel is 376.3 mm×301.1 mm and resolution thereof is 1280×1024 (SXGA) will be described. Further, a 19-inch liquid crystal panel (376.3 mm×301.1 mm, SXGA) and a 17-inch liquid crystal panel (337.92 mm×270.34 mm, SXGA) each having a structure in which no connecting point Pnm is provided in a display area will be described by way of comparison. The liquid crystal panel shown in the exemplary embodiments of the present invention operates as a dot inversion type. The dot inversion type carries out a polarity inversion drive in which polarity of a data signal supplied from a data circuit 6 is inverted with respect to that of common potential applied to a common storage line 8 from a common potential supply circuit 5, and outputs an inverse polarity signal in TFTs adjacent to the TFT on the right, left, up and down. Further, the common storage lines are connected to the counter electrode formed on the counter substrate at four points of C1, C2, C3, C4 shown in FIG. 4 (outside the display area).

Here, a screen display of the liquid crystal panel was checked. By causing the liquid crystal panel to display a subpixel checkered pattern in which adjacent sub-pixels as shown in FIG. 5 are repeatedly turned on and off, a flickering phenomenon (also referred to as a “flicker”) of the screen was checked. Each of R, G and B of one RGB in FIG. 5 is a subpixel, and a set of RGB (shown with a heavy line) is a pixel. In this case, a subpixel having a dotted region indicates a subpixel that is cased to be turned on, and a subpixel having no mark indicates a subpixel that is caused to be turned off. In the 17-inch liquid crystal panel in which the common storage line 8 is not electrically connected to the counter electrode 12 formed on the counter substrate 3 at the point Pnm on the common storage line 8, that is, no connecting point Pnm is provided, there was little flicker by the display. However, in the 19-inch liquid crystal panel having a structure in which no connecting point Pnm is similarly provided, a flickering phenomenon (also referred to as a “flicker”) occurred at a region from the vicinity of the center of the display area to the vicinity of the connecting point C3.

Further, in the 19-inch liquid crystal panel the electric connecting point is provided in the vicinity of the center of the screen as the connecting point Pnm, no flicker occurred in the vicinity of the center of the display area, but a flicker was also recognized at the region in the vicinity of the connecting point C3. Moreover, the display area 28 of the 19-inch liquid crystal panel was divided into 5×5=25 portions as shown in FIG. 6, and each point in the vicinity of an intersection of dividing lines (shown with a broken line) on the common storage line 8 is set to a connecting point Pnm (total 16 points). In this case, in a check to display a checkered pattern on the sub-pixels, no flicker was recognized at the whole screen. Thus, in the 19-inch liquid crystal panel in which no connecting point Pnm is provided or one connecting point Pnm is provided at the central portion, a flicker was recognized. On the other hand, in the 17-inch liquid crystal panel and the 19-inch liquid crystal panel in which a plurality of connecting points Pnm are provided, no flicker was recognized.

The relationship between occurrence of this flicker, the gate signal voltage Vg of the pixel TFTnm in the liquid crystal panel, the data signal voltage Vd, and an operating waveform of the common storage potential Vc was examined. FIG. 7 shows an operating waveform in the 17-inch liquid crystal panel. FIG. 8 shows an operating waveform in the 19-inch liquid crystal panel having a structure in which no connecting point Pnm is provided. In the 17-inch liquid crystal panel in which no flicker is recognized, the common storage potential Vc is restored to the reference potential before the gate signal voltage Vg becomes a low potential state. The relationship between a data entry period tg when the gate line becomes low potential since potential variation of the data line and a restoration period tc of the common storage potential is tc<tg. On the other hand, in a pixel of the 19-inch liquid crystal panel in which a flicker is recognized, the common storage potential Vc is not restored to the reference potential at the time when the gate signal voltage Vg becomes a low potential state. The relationship between the data entry period tg and the restoration period tc of the common storage potential is tc>tg.

The restoration period tc of the common storage potential Vc is a period of time when potential of the common storage line 8 is uplifted by means of a signal from the data line 9 and the uplift is caused to be restored to the reference potential by the common potential supply circuit 5. The restoration period tc is the signal propagation delay time from the common potential supply circuit 5 to the common storage line 8 in each pixel. Here, wiring resistance from the common potential supply circuit 5 to the connecting point A between the common potential supply circuit 5 and the TFT substrate 2 is sufficiently small. In this case, the restoration period tc is the signal propagation delay time due to resistance from the point Pnm of the common storage line in each pixel to the connecting point A (including a counter electrode 12 connected three-dimensionally).

Therefore, resistance from the point Pnm of the common storage line positioned within an area enclosed with arbitrarily adjacent data lines (Yn, Yn+1) in the display area and arbitrarily adjacent gate lines (Xm−1, Xm) in the display area to the connecting point A needs to be reduced. It becomes important to reduce the resistance, to make the signal propagation delay time from the common potential supply circuit 5 smaller, and to shorten the restoration period tc of the common storage potential. In order to reduce the resistance, the present invention is characterized by connecting the counter electrode 12 disposed on the counter substrate 3 to the common storage line at the point Pnm in the display area.

In the 19-inch liquid crystal panel in which no connecting point Pnm is provided in the display area, the relationship of tc>tg as shown in FIG. 8 was checked in a region in which a flickering phenomenon was recognized. However, in the similar 19-inch liquid crystal panel, the relationship of tc<tg was checked in a region in which no flickering phenomenon was recognized, as well as the 17-inch liquid crystal panel. Further, in the 19-inch liquid crystal panel in which the display area 28 thereof was divided into 5×5=25 portions as shown in FIG. 6 and each point in the vicinity of an intersection of dividing lines on the common storage line 8 is set to a connecting point Pnm (total 16 points), the relationship of tc<tg as shown in FIG. 7 was checked in all of the pixels.

It became clear that the relationship between the restoration period tc and the data entry period tg becomes a relationship as shown in Table 1 by collecting them. Namely, by providing a suitable connecting point Pnm so as to become the relationship of tc≦tg, a flickering phenomenon can be removed. Here, a double circular mark indicates that no flickering phenomenon is visible (flicker measurement: −40 dB or lower, 30 Hz), a circular mark indicates that no flickering phenomenon is visible (flicker measurement; −30 dB or lower, 30 Hz), a triangular mark indicates that a flickering phenomenon is slightly visible (flicker measurement: −25 dB or lower, 30 Hz), and a cross mark indicates that a flickering phenomenon occurs (flicker measurement: −20 dB or lower, 30 Hz).

TABLE 1

| | Tc/tg | | | | | | | | | |
|---|---|---|---|---|---|---|---|---|---|---|
| | 0.5 | 0.6 | 0.7 | 0.8 | 0.9 | 1.0 | 1.1 | 1.2 | 1.3 | 1.4 |
| Flickering Phenomenon | ⊚ | ⊚ | ⊚ | ⊚ | ◯ | ◯ | Δ | Δ | X | X |

It is effective that a resistance value of the wiring is caused to be reduced as a method of improving the wiring delay. For the purpose of this, in the conventional liquid crystal panel, a low-resistance metal is adopted as a wiring material, and aluminum (hereinafter, referred to as “Al”) or an alloy mainly made of Al is adopted as a typical example. In the case of using a sputtering method or the like that is a typical method of making a film, specific resistance of Al or an Al alloy is about 5 to 10 μΩcm. In order to reduce wiring resistance by means of a method other than selection of a material, a wiring width or a film thickness is to be made larger. However, when a wiring width is made large, an opening ratio is caused to be lowered. This leads to deterioration of brightness.

A line width of 20 μm or more is undesirable for a practical use in a general high-resolution (XGA, SXGAor higher resolution) liquid crystal panel. Further, the film thickness has a limitation because a coverage characteristic is deteriorated by making the film thickness thicker. For example, in a bottom gate type TFT, a silicon nitride film is used as a gate insulation film, and its film thickness is about 300 nm. For that reason, in view of the coverage characteristic, the wiring film thickness is limited to about 300 nm. Thus, there is difficulty to change a material, a wiring width or a film thickness. For the reasons stated above, in a high-resolution liquid crystal panel, the structure of the liquid crystal panel of the present invention provides effective means against deterioration of picture quality, such as a flicker, with a screen size of the liquid crystal panel being large-sized.

In the first exemplary embodiment, the common storage line and the counter electrode is connected to each other by means of the conductive convex structure in the display area, whereby wiring resistance of the common storage line is reduced. By reducing the wiring resistance of the common storage line, a restoration period tc of the common storage line is made shorter than a data entry period tg. By restoring the common storage line to the reference potential for the data entry period, the liquid crystal panel in which no flicker occurs and the liquid crystal display using the same can be obtained.

### Exemplary Embodiment 2

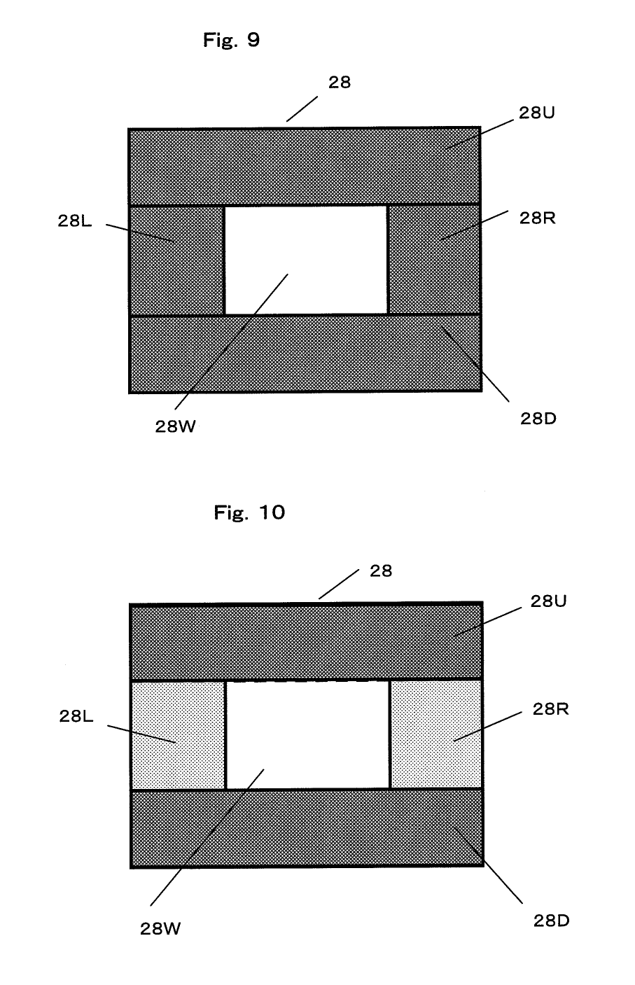

A second exemplary embodiment of a liquid crystal panel according to the present invention will now be described with reference to FIGS. 9 and 10. FIG. 9 shows a display screen in which a halftone is displayed in every one column in sub-pixels of the whole display screen and a window screen of whole white is displayed in the vicinity of the center of the screen. FIG. 10 shows a display screen for explaining display abnormality in which different brightness occurs in FIG. 9. In second embodiment, a 19-inch liquid crystal panel including the structure similar to that of the liquid crystal panel described in first embodiment will also be described. In FIGS. 9 and 10, a display area 28 is divided into a window display area 28W in the center thereof, a display area 28U at an upper portion thereof, a display area 28D at a lower portion thereof, and display areas 28L and 28R at left and right portions thereof.

As shown in FIG. 9, in the case where a halftone is displayed in every one column in sub-pixels of the whole display screen and a window screen of whole white is displayed in the vicinity of the center of the screen, the display areas 28U, 28R, 28L and 28D should normally become the same brightness. However, in the 19-inch liquid crystal panel having the structure in which no connecting point Pnm is provided in the display area, display abnormality occurs that brightness in the areas 28U, 28R, 28L and 28D to be normally displayed with the same brightness is different from each other as shown in FIG. 10 (hereinafter, referred to as “crosstalk”). At this time, it was displayed so that brightness of the areas 28U and 28D is dark and brightness of the areas 28L and 28R is light.

This phenomenon is caused by the following reasons. In a dot inversion drive system, when display in every one column in sub-pixels is carried out, voltage is applied to the same polarity side in pixels lined laterally. Since the common storage line is common to the pixels lined laterally, common potential is drawn in one direction. There is no program in the case where the common potential is restored to the original reference before the gate signal voltage Vg is lowered. However, if not so, writing to pixels is insufficient, whereby normal display cannot be carried out. Namely, since sufficient writing to the areas 28U, 28D cannot be carried out, they becomes dark. However, in the case where any screen of whole white or the like exists in a part of the screen, the number of pixels to become the same polarity is reduced by just that much. Thus, a deflection width of the common potential is made smaller, and writing insufficiency is reduced. For that reason, the areas 28L, 28R become light relatively.

Such different brightness occurs because the common storage potential Vc cannot be restored to the original reference potential before the gate signal voltage Vg is lowered and thus sufficient writing cannot be carried out. This is caused by the fact that resistance Rc of the common storage line formed in parallel is larger than resistance Rg of the gate line. Therefore, it is essential that the resistance Rc of the common storage line is made smaller than the resistance Rg of the gate line in order to cause brightness of the whole screen to be uniformed. Namely, it is required that the relationship between the gate resistance Rg and the common resistance Rc becomes Rc<Rg. The gate resistance Rg is resistance between a gate electrode of a pixel TFTnm in the liquid crystal panel and a connecting point Bm to the scanning circuit 4. The common resistance Rc is resistance between a point Pnm of the common storage line and a connecting point A of the common potential supply circuit 5.

For example, in the case where each of a gate line width and a common storage line width is set to 20 μm and a film thickness is set to 0.3 μm, the gate resistance Rg in the vicinity of the center of the screen became about 2.2 kΩ, while the common resistance Rc became about 4 kΩ. On the other hand, when the connecting point Pnm to the counter electrode is provided in the vicinity of the center of the screen, the common resistance Rc was reduced to about 1.8 kΩ. Thus, no crosstalk by display of the window screen was recognized in the vicinity of the center of the screen. However, since there is a portion of display abnormality in a region other than the vicinity of the center of the screen, it is desirable that a connecting point to the counter electrode is further provided so that the relationship becomes Rc<Rg in any pixel TFTnm of the screen.

Preferably, points to electrically connect to the common storage line 8 formed on the TFT substrate 2 are arranged with density distribution that is to be uniformed in spite of resistance distribution of the independent common storage line formed on the TFT substrate 2. For this purpose, it is desirable that the density distribution of the connecting point in the display area has distribution in which its density in a portion of the display area far from the connecting point A to the common potential supply circuit 5 is thickened and the density is thinned as the portion of the display area approaches the connecting point A. Further, according to the present invention, it is not essential that a width of the common storage line is made equal to or larger than a width of the gate line for the purpose of reducing signal propagation delay of the common storage line, increase in an opening ratio is expected by making the common storage line thin.

In the second exemplary embodiment, the common storage line and the counter electrode are connected to each other in the display area, whereby the wiring resistance of the common storage line is to be reduced. By reducing the wiring resistance of the common storage line to reduce the resistance of the gate line, it is possible to prevent display abnormality of different brightness. Thus, the liquid crystal panel capable of preventing display abnormality and the liquid crystal display using the same can be obtained.

### Exemplary Embodiment 3

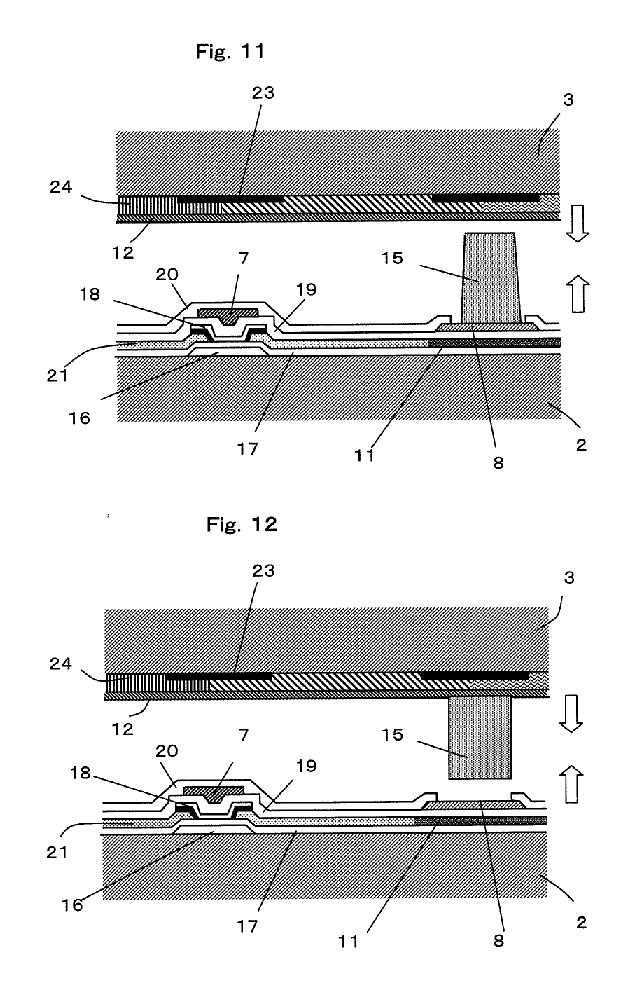

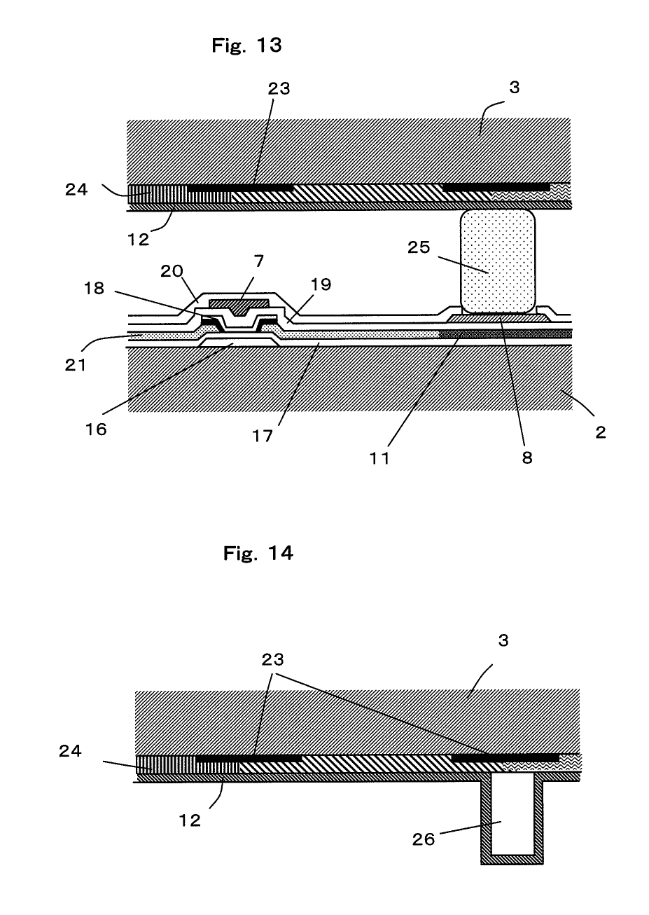

A third exemplary embodiment of a liquid crystal panel and a liquid crystal display using the same according to the present invention will now be described with reference to FIGS. 11 to 16. The third exemplary embodiment is an embodiment about a method of forming a conductive convex structure to connect a common storage line to a counter electrode and the configuration thereof. FIG. 11 shows a sectional view of a first form of a conductive convex structure a conductive convex structure integrally formed at a TFT substrate side. FIG. 12 shows a sectional view of a second form of a conductive convex structure a conductive convex structure integrally formed at a counter substrate side. FIG. 13 shows a sectional view of a third form of a conductive convex structure a liquid crystal panel using a conductive convex structure formed by means of a conductive adhesive. Each of FIGS. 14 to 16 shows a sectional view of a configuration of the conductive convex structure. Here, a drawn portion from the TFT is shown.

FIG. 11 shows a sectional view of a first form of a conductive convex structure a conductive convex structure 15 integrally formed at a TFT substrate 2. The conductive convex structure 15 of the TFT substrate 2 is connected to a common storage line 8. A black matrix (light shielding element) 23 is partially formed on the substrate at the counter substrate 3 side, and a color layer 24 is formed so as to cover the black matrix (light shielding element) 23 and the counter substrate 3. A counter electrode 12 is formed so as to further cover the color layer 24. The TFT substrate 2 and the counter substrate 3 are bonded in up and down direction as shown by arrows in FIG. 11, whereby the common storage line 8 and the counter electrode 12 are connected to each other by means of the conductive convex structure 15.

FIG. 12 shows a sectional view of a second form of a conductive convex structure a conductive convex structure 15 integrally formed at a counter substrate 3. The conductive convex structure 15 on the counter substrate 3 is connected to a counter electrode 12. A TFT substrate 2 and the counter substrate 3 are bonded, whereby a common storage line 8 and a counter electrode 12 are electrically connected to each other by means of the conductive convex structure 15. In FIG. 13, the common storage line 8 on the TFT substrate 2 is connected to the counter electrode 12 of the counter substrate 3 through a paste made of Ag or the like or a conductive adhesive 25.

Moreover, although a staggered type TFT has been illustrated as an example in FIGS. 11 to 13, the present invention is not limited to these embodiments, and an inverted staggered type TFT may be selected. Furthermore, in FIGS. 11 to 13, a protective film 20 is formed on the gate electrode, and an opening is formed on the common storage line 8 for electric connection. However, the conductive convex structure 15 and the common storage line 8 may be electrically connected to each other without forming the protective film itself. Further, it is desirable that the conductive convex structure and the TFT are formed on a region in which the light shielding element such as the black matrix 23 is formed as shown in FIGS. 11 to 13. However, they are not particularly limited.

Next, a configuration of a conductive convex structure is shown. Although in this explanation the conductive convex structure is formed on the counter substrate 3 as an integral configuration, it may be integrally formed on the TFT substrate 2. FIG. 14 shows a first example of a configuration of the conductive convex structure. A columnar structure 26 is formed at a predetermined position of a counter substrate 3 so as to overlap with a common storage line 8 formed on a TFT substrate 2 at an arbitrary position. The columnar structure 26 is formed on a color layer 24 formed on the counter substrate, and a transparent conductive film is further formed as a counter electrode 12 so as to cover the color layer 24 and the columnar structure 26.

This columnar structure 26 needs not to have a conductive property. An arbitrary material including a resin such as epoxy, acryl, polyamide and polyimide and a complex in which any of these resins is to be a matrix can be selected. Moreover, it may be formed with the same material as that of the color layer at the same time. In this regard, color layers such as RGB for colors may be arranged in the color layer. As a forming method, an additive method using a photolithography technique, a semi-additive method or a subtractive method is suitable because a minute structure can be formed reproducibly. Further, a forming method using a screen printing method, an offset printing method or the like is also suitable as an inexpensive manufacturing method. The columnar structure 26 is covered with the transparent conductive film to become the conductive convex structure as the whole. The transparent conductive film may be an Indium Tin Oxide (ITO) film or the like, and a conductive polymer may be selected.

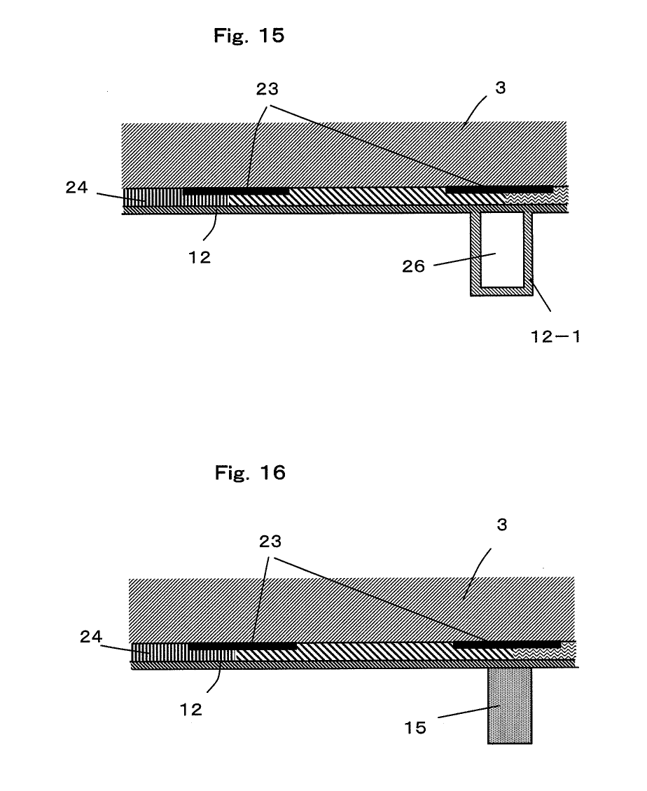

FIG. 15 shows a second example of a configuration of the conductive convex structure. A transparent conductive film is formed on the whole area of a color layer 24 formed on a counter substrate 3 to form a first counter electrode 12. Subsequently, a columnar structure 26 is formed on the transparent conductive film at a predetermined position of a counter substrate 3 so as to overlap with a common storage line 8 formed on a TFT substrate 2 at an arbitrary position. This columnar structure 26 is covered, and a conductive film is formed so as to be electrically connected to the first counter electrode 12 to become a second counter electrode 12-1. The transparent conductive film that forms the first counter electrode 12 may be an ITO film or a conductive polymer.

Further, in order to form the columnar structure 26 at a position opposed to the common storage line 8 when the counter substrate 3 and the TFT substrate 2 are overlapped, it is desirable that the columnar structure 26 is formed on a region at which a light shielding element such as a black matrix 23 is formed as shown in FIG. 15. For this reason, the conductive film to form the second counter electrode 12-1 needs not to be a transparent conductive film, and it may be formed using vapor deposition of a metallic material, sputtering or the like. Further, it may be made of a material other than that of the first counter electrode 12, or the same material may be selected.

Since the columnar structure 26 is covered with the second counter electrode 12-1, it needs not to have a conductive property. It may be made of a resin such as epoxy, acryl, polyamide and polyimide or a complex in which any of these resins is to be a matrix. As a forming method, an additive method using a photolithography technique, a semi-additive method or a subtractive method is suitable because a minute structure can be formed reproducibly. Further, a forming method using a screen printing method, an offset printing method or the like is also suitable as an inexpensive manufacturing method.

FIG. 16 shows a third example of a configuration of the conductive convex structure. A counter electrode 12 composed of a transparent conductive film is formed on the whole area of a color layer 24 formed on a counter substrate 3. A conductive convex structure 15 is formed on the transparent conductive film at a position so as to overlap with a common storage line 8 formed on a TFT substrate 2 at an arbitrary position. The conductive convex structure 15 is not combination of a conductive film and a columnar structure like the configuration in the first and second examples, but the conductive convex structure 15 itself is formed of a material having a conductive property.

The conductive convex structure 15 may be a conductive polymer. The conductive polymer may be polythiophene, polypyrrole, polyaniline, polyacetylene, polyparaphenylene or polyacene. Further, the conductive polymer may be a complex of plural materials selected from them. As a forming method, a counter electrode by the transparent conductive film is used as an electrode of electrolytic polymerization, and precursors are polymerized to form a film. This method is suitable because a large-sized area can be formed in a lump. For example, a method of forming a polypyrrole film in which a counter substrate on which a counter electrode is formed is dipped in an acetonitrile solution containing pyrrole at proper concentration and voltage is applied to the counter electrode as a positive electrode, or the like may be used.

Further, the conductive convex structure 15 may be made of a composite of a resin and metal (resin/metal composite) or a composite of a resin and carbon (resin/carbon composite). The resin may be any of epoxy, acryl, polyamide, polyimide and the like, and it is preferable that it is cured at low temperature. In the case of using a color filter substrate made of an organic substance, its heat-resistant temperature or lower is desirable. More specifically, in the case of using acryl, it is 270° C. or lower. However, in order to prevent thermal strain from occurring in a glass used in the counter substrate or the TFT substrate, 200° C. or lower is desirable, and in order to avoid thermal contraction of a deflection plate, 150° C. or lower is further desirable. Moreover, the resin may be a resin that is cured at a process other than heating, such as UV sure. In the case where the resin is a resin that contracts at a curing process, it is more preferable because contact with metal particles to be contained is promoted and a conductive property appears. The metal may be any of Au, Ag, Cu, Pt, Ni and the like. The shape is any of a spherical shape, a flaky shape, an amorphous shape and the like, but one in which spherical-shaped particles are mixed with proper particle size distribution is preferable because an application property and uniformity after application can be kept. Further, by containing flaky-shaped particles, it is preferable because the number of contacts between the conductive particles is increased and a conductive property is thus heightened.

Further, in the case where particles each having a particle size of 100 nm or less are contained, it is further preferable that sintering progresses with heat treatment of about 100 to 200° C. to cure the resin, and a conductive property is improved. In the case where this particle size is 50 nm or less and further 20 nm or less, it is further preferable that sintering temperature becomes 150° C. or lower and 100° C. or lower, respectively. The similar effects can be obtained even in the case where the metal is changed to carbon. The carbon is preferable because it is inexpensive compared with a metallic material. Further, the conductive convex structure may be formed of metal. The metal may be any of Au, Ag, Pt, Cu, Ni and the like, but Cu, Ni or the like is preferable because it is inexpensive. As a forming method, an additive plating method using a photolithography method, further metal nanoparticle and the like are preferable because a minute structure can be formed.

By forming a conductive convex structure by means of the configuration of the above conductive convex structure and the forming method, the liquid crystal panel of the first or second exemplary embodiment can be obtained. By electrically connecting the counter electrode formed on the counter substrate to the common storage line formed on the TFT substrate in the display area by means of the conductive convex structure, the liquid crystal panel in which no flicker and no crosstalk occur can be obtained. The liquid crystal panel having good picture quality and the liquid crystal display using the same can be obtained.

### Exemplary Embodiment 4

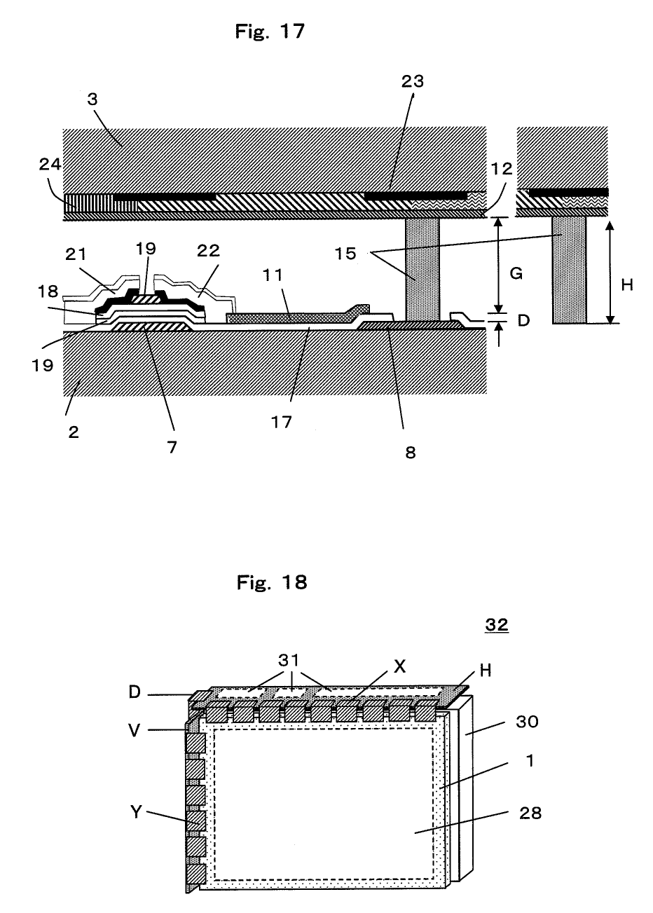

A liquid crystal panel and a liquid crystal display using the same according to a fourth exemplary embodiment of the present invention will be described with reference to FIG. 17. The fourth exemplary embodiment is an embodiment relating to a dimension (size) of the conductive convex structure. FIG. 17 shows a sectional view of a liquid crystal panel.

A common storage line 8 formed on a TFT substrate 2 is covered with an insulation film 17 that is a protective film, a part of the insulation film is opened. A conductive convex structure 15 is disposed at the opening, and the common storage line 8 and the counter electrode 12 are connected to each other. By making this opening larger than an area of a bottom surface of the conductive convex structure 15, the conductive convex structure 15 can be formed without displacement, and such an opening is preferable. Here, “H” is assigned to a height of the conductive convex structure 15, “D” is assigned to a depth of the opening, and “G” is assigned to a gap between the TFT substrate 2 and the counter substrate 3. The height of the conductive convex structure 15 is a height when to form it on the counter substrate. This height H of the conductive convex structure 15 is set to a value equal to or larger than the sum of the depth (D) of the opening and the gap (G) between the TFT substrate and the counter substrate (i.e., H≧G+D). Namely, the height of the conductive convex structure 15 is larger than the gap. In the case where the liquid crystal panel has a configuration in which the counter substrate and the TFT substrate are compressed by bonding them, it is preferable because electric connection is stabilized. In this regard, in the case where the conductive convex structure 15 has elasticity so that the height of the compressed conductive convex structure 15 is restored to the as-manufactured height H when the counter substrate is separated from the TFT substrate, it is preferable because the electric connection is further stabilized.

The gap (G) between the TFT substrate and the counter substrate is required to uniform the dimension by providing a spacer between the TFT substrate and the counter substrate. For example, by dispersing spherical-shaped particles each having a uniform diameter, the dimension of the gap (G) can be uniformed. Further, in the case where the gap (G) between the TFT substrate and the counter substrate is set to a distance to be held by compressing the conductive convex structure 15, it is preferable because it eliminates the need for the spacer. In the case where combination of the spacer and the conductive convex structure 15 cause the gap (G) to be uniformed, it is also preferable because a spacer material can be reduced.

In the fourth exemplary embodiment, the size of the conductive convex structure in which the common storage line and the counter electrode are connected to each other in the display area is optimized, whereby electric connection can be stabilized. The conductive convex structure whose size is optimized allows the wiring resistance of the common storage line to be reduced. By reducing the wiring resistance of the common storage line, the liquid crystal panel capable of reducing a flicker and crosstalk and the liquid crystal display using the same can be obtained.

In the liquid crystal panel of the present invention, the common storage line and the counter electrode are connected to each other in the display area, whereby the wiring resistance of the common storage line is to be reduced. By reducing the wiring resistance of the common storage line, a flicker and crosstalk can be reduced. By providing the configuration of the present invention, even in a large-sized liquid crystal panel, the liquid crystal panel having good picture quality and the liquid crystal display using the same can be obtained.

Further, FIG. 18 shows a configuration diagram of a liquid crystal display using the liquid crystal panel of the present invention described above. For example, a liquid crystal display 32 includes the liquid crystal panel 1 of the present invention, a drive circuit 31, and a light source 30 for backlighting. The drive circuit 31 includes the control circuit 29, the data circuit 6, the common potential supply circuit 5, and the scanning circuit 4, which are shown in FIG. 4, and the drive circuit are arranged on the circuit board H and the circuit board V. The circuit board V is connected to the circuit board H through a connection board D. The circuit board H is connected to the liquid crystal panel 1 through connection boards X. The circuit board V is connected to the liquid crystal panel 1 through connection boards Y. Further the light source 30 includes a backlight control circuit. The inside of the display area 28 is a region in which a screen is displayed. By using the liquid crystal panel of the present invention, even in a large-sized liquid crystal panel, the liquid crystal panel having good picture quality and the liquid crystal display using the same can be obtained.

As described above, in the liquid crystal panel of the present invention, the counter electrode of the counter substrate is connected to the common storage line of the TFT substrate in the display area by means of the conductive convex structure. Thus, it is possible to obtain the effects that resistance of the common storage line can be reduced and signal propagation delay time can be shortened. The counter electrode and the common storage line are connected by means of the conductive convex structure so that wiring resistance of the common storage line becomes a resistance value equal to or less than gate wiring resistance. Thus, by reducing the resistance of the common storage line, and setting the potential restoration period of the common storage line to a length of a period of time equal to or shorter than a data entry period, a screen of good quality can be obtained. Further, the liquid crystal display can be configured using the liquid crystal panel of the present invention, and the liquid crystal display is provided with at least a drive circuit and a light source for backlighting. According to the configuration of the present invention, the liquid crystal panel in which a flicker and crosstalk can be reduced and the liquid crystal display using the same can be obtained.

A liquid crystal panel of the present invention is a liquid crystal panel including a structure in which a counter substrate and a TFT substrate are bonded with a seal material and a liquid crystal material is filled between the counter substrate and the TFT substrate, wherein a plurality of pixels in each of which a gate line, a common storage line and a data line are arranged so that the data line intersects with the gate line and the common storage line are arranged in a display area in a matrix manner, the common storage line formed on the TFT substrate is connected to wiring from the common potential supply circuit outside the display area and further connected to the counter electrode formed on the counter substrate, and the gate line formed on the TFT substrate is connected to wiring from the scanning circuit outside the display area, and wherein in each pixel of the display area, the common storage line and the counter electrode in the display area are connected to each other so that common wiring resistance (Rc) from a point at which a common storage line and a storage capacitor are connected to each other to a point at which the common storage line is connected to wiring from the common potential supply circuit becomes a resistance value equal to or less than gate wiring resistance (Rg) from a gate electrode to a point at which the gate line is connected to wiring from the scanning circuit.

In the liquid crystal panel of the present invention, connecting points at each of which the common storage line and the counter electrode in the display area are connected to each other by means of a conductive convex structure are arranged with density distribution in which the common wiring resistance becomes a uniform resistance value.

The density distribution in the liquid crystal panel of the present invention has distribution in which density in a portion of the display area far from the connecting point to the common potential supply circuit is thickened and the density is thinned as a portion of the display area approaches the connecting point.

The common storage line in the liquid crystal panel of the present invention is formed from an opaque film, and a contact with the counter electrode is disposed on the opaque film. Further, the common storage line in the liquid crystal panel of the present invention has a shape in which a storage capacitor is formed against a pixel electrode.

The common storage line and the counter electrode in the display area in the liquid crystal panel of the present invention are electrically connected to each other by means of the conductive convex structure.

The conductive convex structure in the liquid crystal panel of the present invention is formed on the counter substrate, and the common storage line and the counter electrode are electrically connected by bonding the counter substrate to the TFT substrate. Further, the conductive convex structure in the liquid crystal panel of the present invention is formed on the TFT substrate, and the common storage line and the counter electrode are electrically connected by bonding the TFT substrate to the counter substrate.

The conductive convex structure in the liquid crystal panel of the present invention is made of a material having an adhesive property, and the common storage line and the counter electrode are electrically connected by bonding the TFT substrate to the counter substrate.

The conductive convex structure in the liquid crystal panel of the present invention is formed from a columnar structure, formed on the counter substrate so as to overlap with the common storage line formed on the TFT substrate at an arbitrary position, and the counter electrode composed of a transparent conductive film so as to cover the columnar structure.

The conductive convex structure in the liquid crystal panel of the present invention, a first counter electrode composed of a transparent conductive film is formed on at least the whole display area of the counter substrate, a columnar structure is formed on the first counter electrode so as to overlap with the common storage line formed on the TFT substrate at an arbitrary position, and a second counter electrode composed of a conductive film is further formed on the columnar structure.

The conductive convex structure in the liquid crystal panel of the present invention, a counter electrode composed of a transparent conductive film is formed on at least the whole display area of the counter substrate, and a columnar structure that is a conductive element is formed on the counter electrode so as to overlap with the common storage line formed on the TFT substrate at an arbitrary position.

The conductive convex structure in the liquid crystal panel of the present invention can be made of either a material containing a transparent conductive film, a material containing a conductive polymer, a composite of a resin and metal, a composite of a resin and carbon, or metal.

The liquid crystal panel of the present invention is has a structure in which the common storage line formed on the TFT substrate is covered with an insulation film, a part of the insulation film is opened, and the conductive convex structure formed on the counter electrode is connected to the common storage line through the opening, and wherein an area of the opening is larger than a cross-section area of the conductive convex structure.

A height (H) of the conductive convex structure in the liquid crystal panel of the present invention is equal to or larger than the sum of a depth (D) of the opening and a gap (G) between the TFT substrate and the counter substrate (i.e., H≧G+D).

Further, a liquid crystal panel of the present invention is a liquid crystal panel including a structure in which a counter substrate and a TFT substrate are bonded with a seal material and a liquid crystal material is filled between the counter substrate and the TFT substrate, wherein a plurality of pixels in each of which a gate line, a common storage line and a data line are arranged so that the data line intersects with the gate line and the common storage line are arranged in a display area in a matrix manner, the common storage line formed on the TFT substrate is connected to wiring from the common potential supply circuit outside the display area and further connected to the counter electrode formed on the counter substrate, and wherein in each pixel of the display area, the common storage line and the counter electrode in the display area are connected to each other so that a potential restoration period (tc) of the common storage line in each pixel becomes a length of a period of time equal to or less than a data entry period (tg).

The common storage line in the liquid crystal panel of the present invention is formed from an opaque film, and a contact with the counter electrode is disposed on the opaque film.

The common storage line and the counter electrode in the display area in the liquid crystal panel of the present invention are electrically connected to each other by means of a conductive convex structure.

The liquid crystal panel of the present invention has a structure in which the common storage line formed on the TFT substrate is covered with an insulation film, a part of the insulation film is opened, and the conductive convex structure formed on the counter electrode is connected to the common storage line through the opening, and wherein an area of the opening is larger than a cross-section area of the conductive convex structure.

As described above, although the present invention has been described in conjunction with the embodiments thereof, the present invention is not limited to the above embodiments. Various modifications that one skilled in the art can understand can be applied to the configuration or details of the present invention without departing from the scope of the present invention. For example, although the present invention has been explained using the dot inversion drive, it should be apparent that one skilled in the art can readily understand that the similar effects can be obtained even in other polarity inversion drive methods such as line inversion drive.

What is claimed is:

1. A liquid crystal panel including a structure in which a counter substrate and a TFT substrate are bonded with a seal material and a liquid crystal material is filled between the counter substrate and the TFT substrate,
wherein a plurality of pixels in each of which a gate line, a common storage line and a data line are arranged so that the data line intersects with the gate line and the common storage line are arranged in a display area in a matrix manner, the common storage line formed on the TFT substrate is connected to wiring from the common potential supply circuit outside the display area and further connected to the counter electrode formed on the counter substrate, and the gate line formed on the TFT substrate is connected to wiring from the scanning circuit outside the display area, and
wherein in each pixel of the display area, the common storage line and the counter electrode in the display area are connected to each other so that common wiring resistance (Rc) from a point at which a common storage line and a storage capacitor are connected to each other to a point at which the common storage line is connected to wiring from the common potential supply circuit becomes a resistance value equal to or less than gate wiring resistance (Rg) from a gate electrode to a point at which the gate line is connected to wiring from the scanning circuit.

2. The liquid crystal panel as claimed in claim 1, wherein connecting points at each of which the common storage line and the counter electrode in the display area are connected to each other by means of a conductive convex structure are arranged with density distribution in which the common wiring resistance becomes a uniform resistance value.

3. The liquid crystal panel as claimed in claim 2, wherein the density distribution has distribution in which density in a portion of the display area far from the connecting point to the common potential supply circuit is thickened and the density is thinned as a portion of the display area approaches the connecting point.

4. The liquid crystal panel as claimed in claim 1, wherein the common storage line is formed from an opaque film, and a contact with the counter electrode is disposed on the opaque film.

5. The liquid crystal panel as claimed in claim 4, wherein the common storage line has a shape in which a storage capacitor is formed against a pixel electrode.

6. The liquid crystal panel as claimed in claim 1, wherein the common storage line and the counter electrode in the display area are electrically connected to each other by means of the conductive convex structure.

7. The liquid crystal panel as claimed in claim 6, wherein the conductive convex structure is formed on the counter substrate, and the common storage line and the counter electrode are electrically connected by bonding the counter substrate to the TFT substrate.

8. The liquid crystal panel as claimed in claim 6, wherein the conductive convex structure is formed on the TFT substrate, and the common storage line and the counter electrode are electrically connected by bonding the TFT substrate to the counter substrate.

9. The liquid crystal panel as claimed in claim 6, wherein the conductive convex structure is made of a material having an adhesive property, and the common storage line and the counter electrode are electrically connected by bonding the TFT substrate to the counter substrate.

10. The liquid crystal panel as claimed in claim 6, wherein the conductive convex structure is formed from a columnar structure, formed on the counter substrate so as to overlap with the common storage line formed on the TFT substrate at an arbitrary position, and the counter electrode composed of a transparent conductive film so as to cover the columnar structure.

11. The liquid crystal panel as claimed in claim 6, wherein in the conductive convex structure, a first counter electrode composed of a transparent conductive film is formed on at least the whole display area of the counter substrate, a columnar structure is formed on the first counter electrode so as to overlap with the common storage line formed on the TFT substrate at an arbitrary position, and a second counter electrode composed of a conductive film is further formed on the columnar structure.

12. The liquid crystal panel as claimed in claim 6, wherein in the conductive convex structure, a counter electrode composed of a transparent conductive film is formed on at least the whole display area of the counter substrate, and a columnar structure that is a conductive element is formed on the counter electrode so as to overlap with the common storage line formed on the TFT substrate at an arbitrary position.

13. The liquid crystal panel as claimed in claim 6, wherein the conductive convex structure is made of a material containing a transparent conductive film.

14. The liquid crystal panel as claimed in claim 6, wherein the conductive convex structure is made of a material containing a conductive polymer.

15. The liquid crystal panel as claimed in claim 6, wherein the conductive convex structure is made of a composite of a resin and metal.

16. The liquid crystal panel as claimed in claim 6, wherein the conductive convex structure is made of a composite of a resin and carbon.

17. The liquid crystal panel as claimed in claim 6, wherein the conductive convex structure is made of metal.

18. The liquid crystal panel as claimed in claim 1, wherein the liquid crystal panel has a structure in which the common storage line formed on the TFT substrate is covered with an insulation film, a part of the insulation film is opened, and the conductive convex structure formed on the counter electrode is connected to the common storage line through the opening, and
wherein an area of the opening is larger than a cross-section area of the conductive convex structure.

19. The liquid crystal panel as claimed in claim 18, wherein a height (H) of the conductive convex structure is equal to or larger than the sum of a depth (D) of the opening and a gap (G) between the TFT substrate and the counter substrate (i.e., H≧G+D).

20. A liquid crystal panel including a structure in which a counter substrate and a TFT substrate are bonded with a seal material and a liquid crystal material is filled between the counter substrate and the TFT substrate,
wherein a plurality of pixels in each of which a gate line, a common storage line and a data line are arranged so that the data line intersects with the gate line and the common storage line are arranged in a display area in a matrix manner, the common storage line formed on the TFT substrate is connected to wiring from the common potential supply circuit outside the display area and further connected to the counter electrode formed on the counter substrate, and
wherein in each pixel of the display area, the common storage line and the counter electrode in the display area are connected to each other so that a potential restoration period (tc) of the common storage line in each pixel becomes a length of a period of time equal to or shorter than a data entry period (tg).

21. The liquid crystal panel as claimed in claim 20, wherein the common storage line is formed from an opaque film, and a contact with the counter electrode is disposed on the opaque film.

22. The liquid crystal panel as claimed in claim 20, wherein the common storage line and the counter electrode in the display area are electrically connected to each other by means of a conductive convex structure.

23. The liquid crystal panel as claimed in claim 20, wherein the liquid crystal panel has a structure in which the common storage line formed on the TFT substrate is covered with an insulation film, a part of the insulation film is opened, and the conductive convex structure formed on the counter electrode is connected to the common storage line through the opening, and
wherein an area of the opening is larger than a cross-section area of the conductive convex structure.

24. A liquid crystal display comprising the liquid crystal panel as claimed in claim 1, wherein the liquid crystal display is provided with at least a drive circuit and a light source for backlighting.

25. A liquid crystal display comprising the liquid crystal panel as claimed in claim 20, wherein the liquid crystal display is provided with at least a drive circuit and a light source for backlighting.
